(19) United States
(12) Patent Application Publication
(10) Pub. No.: US 2007/0047875 A1
(43) Pub. Date: Mar. 1, 2007

(54) Remote monitoring of optical fibers

(75) Inventors: Omur M. Sezerman, Kanata (CA); Gordon Youle, Stittsville (CA)

Correspondence Address: JONES, TULLAR & COOPER, P.C., P.O. BOX 2266 EADS STATION, ARLINGTON, VA, 22202, US

(73) Assignee: Oz Optics Ltd.

(21) Appl. No.: 11/508,311

(22) Filed: Aug. 23, 2006

Related U.S. Application Data
(60) Provisional application No. 60/710,189, filed on Aug. 23, 2005.

(51) Int. Cl. G02B 6/26

(52) U.S. Cl. 385/48

(57) ABSTRACT

An optical fiber monitoring arrangement includes a monitoring fiber formed from an optical fiber having a core and a cladding and suitably modified to include a zone of altered refractive index defining an optical channel extending from the core to the outer surface of the fiber. The channel is capable of diverting therealong a portion of light traveling along the core. A detector positioned adjacent the monitoring fiber receives light diverted along the channel and transforms the diverted light into an electrical signal. The electrical signal can then be conveyed, preferably wirelessly, to an appropriate receiver for further processing and analysis. The arrangement is particularly useful in monitoring optical networks at remote locations and signaling service personnel of problems detected in the network, as determined by changes in, for example, the strength of the light diverted to the detector.

### CROSS REFERENCE TO RELATED APPLICATIONS

This application claims the benefit of provisional patent application No. 60/710,189 filed Aug. 23, 2005.

### FIELD OF THE INVENTION

The present invention relates to the monitoring of optical fibers, particularly with respect to the optical power transmitted by such fibers in an optical fiber network, although it is not limited to such applications.

### BACKGROUND OF THE INVENTION

Optical networks are well known, being used in many applications, whether within an office building, a residential home, a village, town or city, or even between cities. Such networks can be subject to stresses and other problems which can affect the operation and/or the efficiency thereof. There is a need for service people to be able to monitor the networks in order to ascertain first of all whether there is a problem with the network, and secondly to ascertain the location of the problem and preferably the nature of the problem. Monitoring of optical networks can be effected in known manners using known equipment. However, such monitoring is generally considered to be active, in that it requires the presence of service personnel to attend at and to connect directly to the networks using hand-held or other testing equipment. There is a need for more efficient monitoring, using equipment that is physically located within the network and which can be monitored from afar, or which can automatically signal a central monitoring station whenever a problem with the network is detected.

Prior art monitoring of optical fibers has used fused couplers to tap a fixed amount of light into another fiber and on to a measuring module. This method is bulky and must be done using discrete components.

International patent application PCT/CA2003/01158, published as WO2004/013668 on Feb. 12, 2004, discloses a method of modifying the refractive index of an optical fiber so as to create various optical waveguides, customized to particular applications. One of the waveguides that can be created by the method of that patent application is an optical tap, being an optical fiber that has been modified so that a portion of the light transmitted therealong is diverted out of the fiber along the modified portion. The diverted light can be detected and measured, the measured diverted light being then compared to the light at the source so as to ascertain the relative strength of the transmitted light with respect to the source. This can be a measure of the transmission efficiency of the fiber. If the measurement falls outside pre-established limits that is an indication of a problem within the network containing the fiber being monitored.

### SUMMARY OF THE INVENTION

The present invention builds on the subject matter of the above-identified international application: by utilizing at least one optical tap as created following the method of that application, within an optical network, by providing a suitable detector in conjunction with the optical tap, which detector is capable of detecting the light diverted from the optical fiber by the tap and providing a measurement of the strength of such diverted light; and by providing signal conveying means in association with the detector for conveying or transmitting a signal indicative of the strength of the diverted light. The signal can be transmitted continuously, at predetermined intervals, in response to an activation signal received from a remote location, or in response to an activation signal received from a reader connected to the transmitter. The signal can be transmitted by any common mechanism, to a central computer, to a hand-held PDA such as a Blackberry®, to a smart cell phone, or to any other type of receiver at which the transmitted signal can be transformed into useful data for interpretation by service personnel. The service personnel can decide whether the network is operating within established limits and whether it is necessary to service the network. Optical taps, detectors and transmitters can be provided at a multitude of locations along the network, with each location being monitored remotely or wirelessly, thereby improving the overall efficiency of the system since service personnel will spend much less time at the network site checking on the operating status thereof.

Much of the cost associated with sending a technician to a site is determined by the travel time to and from the installation of interest. It takes a considerable amount of time (and money) to drive to a location, park the vehicle, unload equipment, find the optical fibers, disconnect the fibers, connect a power meter, take a reading, and then reverse the entire process. Using the technology of the present invention, this task can be performed many thousands of times faster by an automated system, without needless down-time or risk to the fibers. Then, if necessary, a repairman can be sent directly to the problem site.

The present invention is not limited to analysing power losses in optical fibers using an optical tap. The present invention, by utilizing appropriate technology with suitable detectors, transmitters and receivers, can be used with any type of optical test equipment by transmitting a detected signal to a remote location for appropriate analysis, thereby saving considerable time, effort and expense for the monitoring operation. Additionally, there is no need to hard wire detectors to monitoring stations, thereby further reducing the monitoring costs. Wireless monitoring and signalling can be used, without limitation, with fiber rangers, OTDR's (Optical Time Domain Reflectometers) or back reflection meters.

### BRIEF DESCRIPTION OF THE DRAWINGS

FIG. 1 is a schematic illustration of an optical tap and power monitoring set-up as taken from the aforementioned international application.

FIG. 2 illustrates in general an optical fiber provided with a power detector and wireless transmitter in accordance with the present invention.

FIG. 3 illustrates schematically an optical fiber network provided with a power meter fiber in accordance with the present invention.

FIG. 4 illustrates schematically remote monitoring of a WDM network.

FIGS. 5, 6, 7 and 8 provide block diagrams for single channel monitoring, bi-directional monitoring, single fiber multi-wavelength monitoring, and single channel monitoring with additional inputs and outputs.

FIG. 9 illustrates schematically multi-channel monitoring in a single package.

### DESCRIPTION OF THE PREFERRED EMBODIMENT

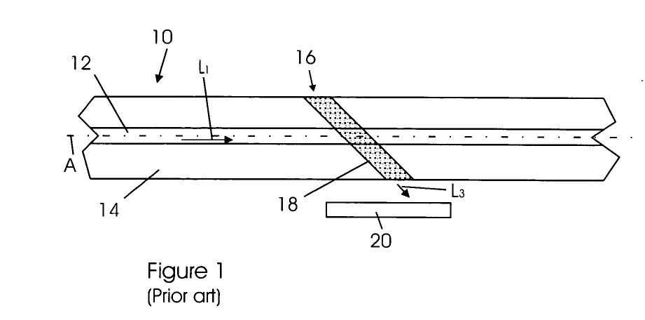

FIG. 1 illustrates, on a large scale, an optical tap arrangement as disclosed in the aforementioned international patent application. An optical fiber 10 has a core 12 and cladding 14 with light L₁ being transmitted along the core in a normal fashion. The optical fiber, however, has been modified in accordance with the principles and methods of the international application so that it has a zone 16 of altered index of refraction oriented at an angle to the fiber axis A, creating an optical tap with a channel 18 leading from the core to the outer surface of the fiber. A portion L₃ (typically about 1%) of the light transmitted along the fiber is diverted from the fiber core along the channel 18 and can be detected by a photodiode detector 20 positioned adjacent the fiber at the exit from the channel. The detector 20 is provided with means, known to those skilled in the art, for converting the received optical signal into an electrical signal. The electrical signal is indicative of the power of the diverted light and can be used to effect a comparison with the known power of the light transmitted along the fiber.

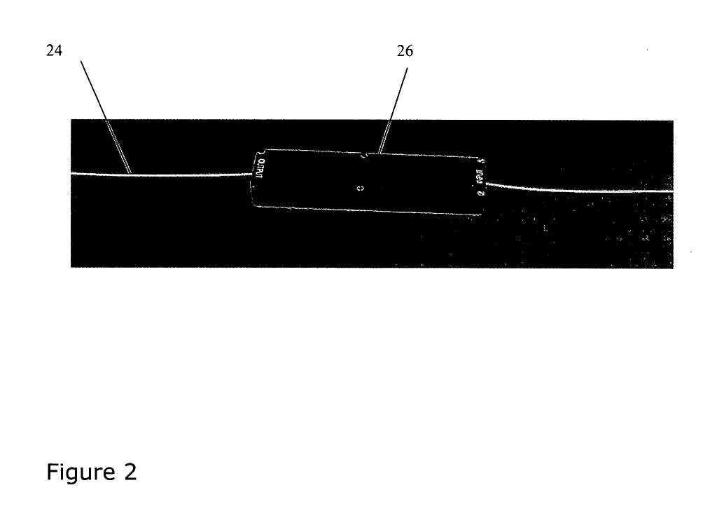

FIG. 2 illustrates schematically an optical fiber 24 similar to the fiber 10 of FIG. 1, and which is provided with a “black box” or housing 26 along the length thereof, which housing surrounds the fiber at the location of the tap or diversion channel 18 and contains the detector 20. The housing 26 also contains a digitizer for converting the optical power detected by the detector 20 into an electronic signal and a wireless transmitter for transmitting the electronic signal to an appropriate receiver. The article of FIG. 2 may be referred to as a SMART PATCHCORD™ or, generically as a “monitor fiber” and it will be referred to as such hereinafter.

Monitor fibers can be used as sensors to monitor the properties of optical signals travelling through fibers, such properties including, without limitation, optical power, optical wavelength, and polarization. The sensors can be integrated into networks and test equipment to provide real-time remote monitoring without interrupting the optical signal or affecting functionality. The sensors are very compact and as suggested above, they resemble a patchcord in construction. Sensors can be made into standard singlemode fiber, polarization maintaining (PM) fibers, or specialty fibers, for any design wavelength. The monitor electronics can be configured to give either an analog electrical output or a digital output via an RS232 or USB port, phone lines, LAN (local area network) lines, or as in the preferred form of the invention herein, via a radio transceiver. Other proprietary or standard digital output formats could be easily accommodated in the monitor fibers of the present invention. Multiple sensor modules can be integrated into a single patchcord, allowing different properties to be measured simultaneously. The sensors are directional in nature, measuring light travelling in one direction through the fiber, but not in the reverse direction. This directionality is ideal for monitoring signals in one direction independently of signals travelling in the other direction. Bi-directional versions can be provided to monitor signals being transmitted in both directions along the fiber.

With the preferred form of the present invention a miniature wireless radio transceiver is built into the sensor module. This permits the monitor fiber to communicate with a host computer, which can be a laptop, a PDA, or even a smart cell phone. This makes it possible in many instances for a technician or service person to identify a problem fiber before entering a building, resulting in a tremendous reduction in troubleshooting time. The transceiver can be provided with various power and transmission capabilities, from say 10 meters to over 1 kilometer.

When a smart cell phone is used in conjunction with a monitor fiber of the present invention, measurements can be instantly sent to a central location for logging, or for comparison to standards or previous measurements in order to monitor degradation of a link. By allowing easy monitoring of optical signal power levels without disrupting the signal, unnecessary maintenance and down time can be virtually eliminated.

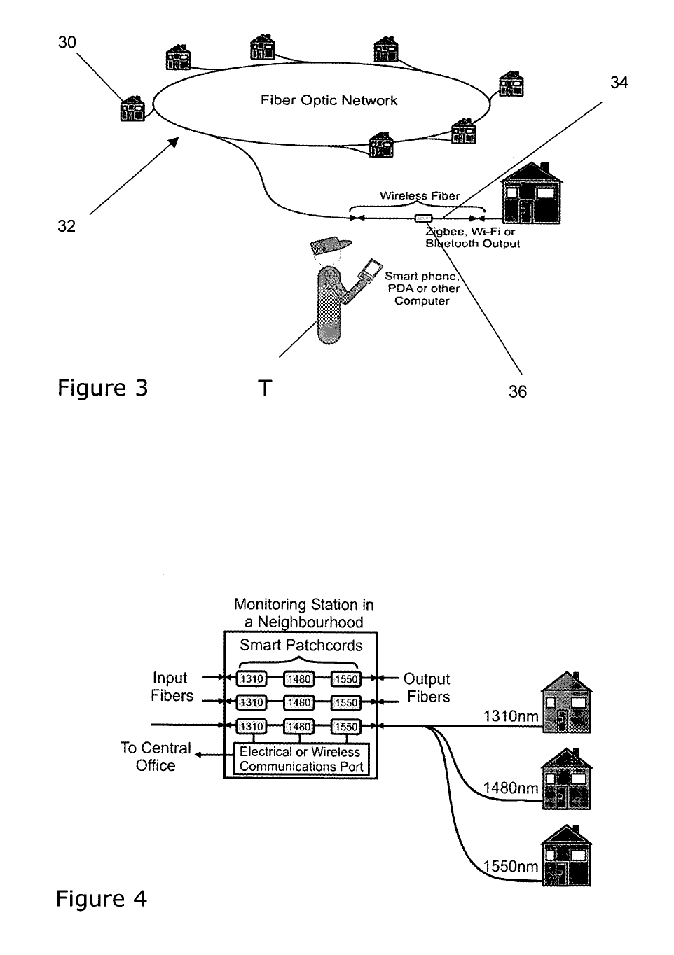

FIG. 3 illustrates schematically a “fiber to the home” (FTTH) network in which a number of buildings or residences 30 are connected optically by way of the optical fiber network 32. The network 32 is provided with a monitor fiber 34 having a built-in sensor module 36 as previously described. Such networks may use a single wavelength source, or multiplex several wavelengths, such as 1310 nm, 1480 nm and 1550 nm to transmit data. Often the optical signal strength through these networks must be measured at each node, to monitor signal quality and to troubleshoot connection problems. It is not uncommon for problems to occur while the technician is checking the signals.

Typically, using current procedures, the technician T has to break the connection, shutting down the node. He then has to measure the relative signal strengths. If there are multiple wavelengths going through the same node, he needs to use an optical spectrum analyser (OSA) or wavemeter, which is costly. Finally, there is a risk of contaminating the fiber ends while disconnecting or reconnecting the node to the network. This can lead to problems later on, and possible further costly repairs.

With the present invention, as shown in FIG. 3, monitor fibers can be built onto the fiber of each node and installed at a convenient location, such as a patch panel. The monitor fibers tap about 1% of the light out and can be designed to receive light only of a specific wavelength. Thus, three units could be used to measure the power levels at three separate wavelengths, without interrupting transmission. Monitor fibers can be provided with an RS232 port, a USB port, any other standard or proprietary digital output means, or, as per the preferred form of the present invention, with the aforementioned wireless transceiver equipment for wireless transmission of the signal directly to the technician's laptop or PDA or to a remote monitoring station where the signal data can be analysed. Depending on the options selected, monitor fibers could be installed on every node of a network at very little cost.

With the wireless set-up of the invention the technician need not make a hard cabled connection to his laptop computer, PDA or smart phone. The invention makes use of an inexpensive radio module and by using that the technician can immediately read the optical power level in any wireless monitor fiber within the operating range thereof, which can be over 1 kilometer. Data encoding is possible to prevent unauthorized reading of the power levels.

In some instances, a visit by a field technician may not even be necessary, as the monitor fiber technology also makes it possible to monitor remote locations via phone lines, using the internet, or by means of long-range radio links. In large buildings or complexes, multiple monitor fibers can be monitored by a single controller, with a single radio or telephone link to a central office.

The flexible design of the monitor fiber means that it is relatively easy to create customized systems to meet the requirements of the user. Almost any fiber length can be provided, and the optical taps can be customized for measuring the parameters of interest.

FIG. 4 shows a WDM (Wavelength Division Multiplexing) system 40 in which three optical taps 42, 44, 46 are incorporated into a single monitor fiber 48 for monitoring the health of three channels of the network. A neighbourhood monitoring station 50 could contain numerous such taps to measure the signal strength for every customer connected to the network.

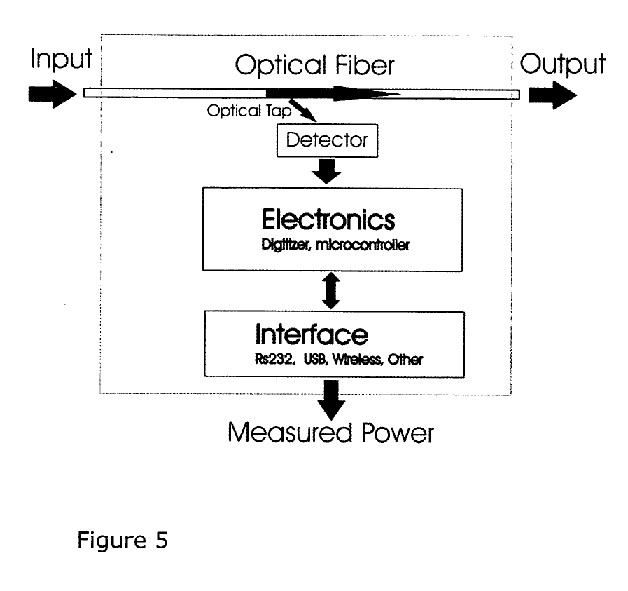

FIGS. 5 to 8 are block diagrams of several, non-limiting, configurations further illustrating the present invention. With reference to FIG. 5 it is seen that a portion of the light L₁ passing through the optical fiber 60 is tapped by an optical tap constructed in accordance with the aforementioned international application. Light L₃ from the optical tap hits a detector 62, which converts the optical signal into an electrical signal. The electronics module 64 amplifies and digitizes the signal. The tapped optical signal is closely related to the total optical power within the fiber. Generally, it is directly proportional to the power passing through the fiber. Either by generating a look-up table or by creating a set of equations that relates the tapped light to the total optical power, the optical power passing through the fiber can be determined.

A microcontroller -64 is used to control the interchange of the readings between the device interface 66 and the outside world. This allows the measured optical signal to be sent to a remote location using any of several common interfaces, including but not limited to, RS232, USB (Universal Serial Bus), phone lines, LAN (local area network) lines, wirelessly (using Bluetooth® or Zigbee®, for example), or other common or proprietary schemes. The signal could even be transmitted using an optical interface, if desired.

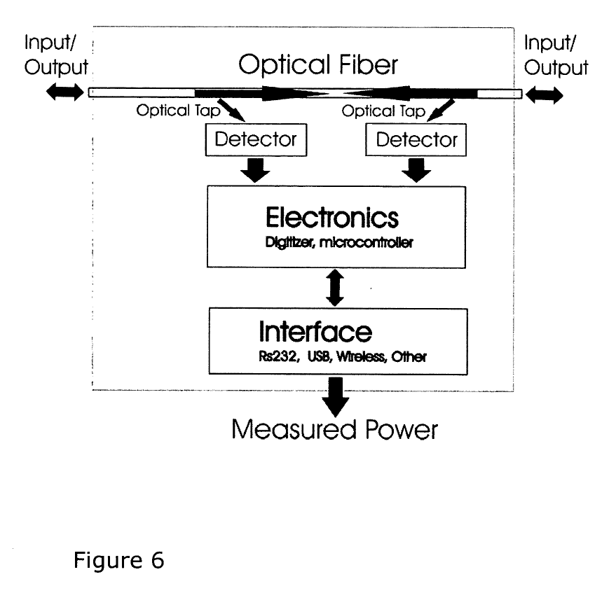

Since optical power may pass through the fiber in either direction, or both, it is possible to measure the optical power in each direction independently by using two optical taps in series, with the taps configured to measure the power in opposing directions. Such a configuration is shown schematically in FIG. 6 where a portion L₄ of the light L₂ traveling from left to right is diverted to the detector 70 while a portion L₆ of the light L₇ traveling from right to left is diverted to the detector 72. It is not necessary to duplicate the entire device, however, as the electronics 74 can be shared between the taps. Only a switch is needed to select one detector or the other. The microcontroller -74 can select the source, based on its program, or from instructions that it receives from an external device, and process the signal accordingly. The technician himself could provide a wireless signal to the transceiver incorporated in the interface 76 so as to avoid physical contact therewith.

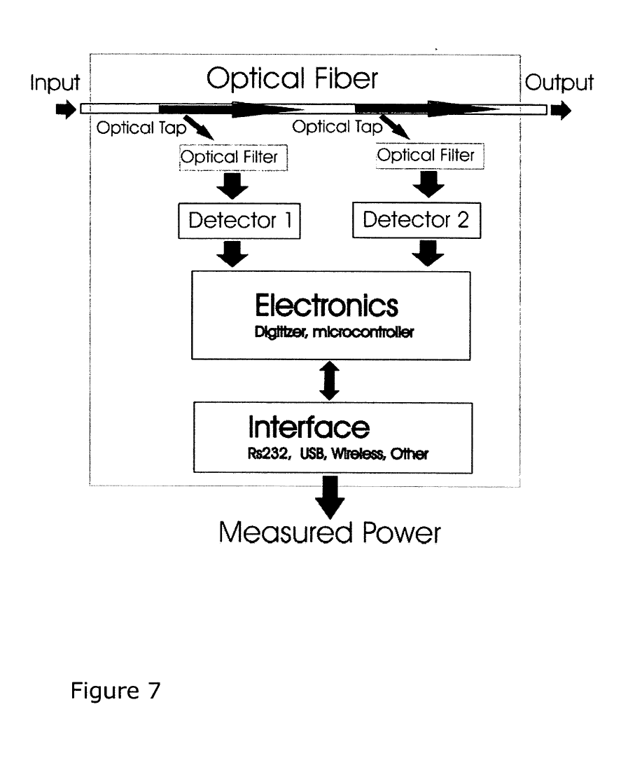

In another incarnation of the device, an optical filter with specific properties can be inserted between the optical tap and the detector. This filter could, for example, allow only certain wavelengths or polarizations to reach the detector, making the measurement wavelength or polarization specific. Such a configuration could allow for the power level of a specific wavelength in a wavelength division multiplexing (WDM) system to be monitored. This can be implemented in devices with one or more optical taps. A two-channel version is shown in FIG. 7. In that version a portion L₉ of the light L₈ diverted to the detector 80 passes first through an optical filter 82 while another portion L₁₀ of the light L₈ diverted to the detector 84 passes through another optical filter 86. Again, the electronics 88 and the interface 90 can be shared as with the embodiment of FIG. 6. Such a technique can be combined with the previously mentioned example, to monitor not only the power at a specific wavelength, but also the direction.

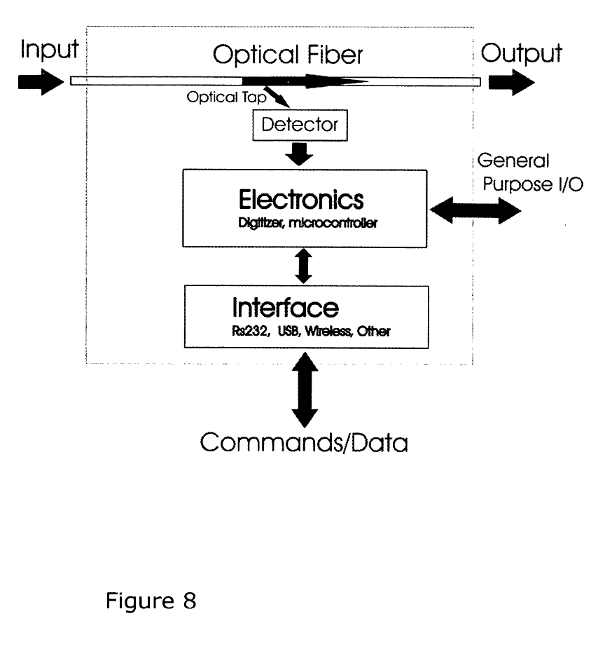

The number of channels that can be monitored is essentially limited only by the number of input channels that can be handled by a multiplexor prior to the analog to digital converter in the electronics section of the circuit. Any extra channels of the multiplexor can be used as general-purpose analog inputs, with suitable signal conditioning. This means that the device is capable of monitoring parameters in addition to the optical power level contained within the fiber. Additional parameters, such as temperature for example, can be measured and added to the data stream that the device produces, as long as the parameter can ultimately be made available as a voltage or current. Extra input/output lines of the microprocessor can also be used to interface to other circuitry, allowing the device to act as a central hub. Since the communications interface is generally bi-directional, it can control external devices as well as collect information that can subsequently be passed through the interface to a host computer. The additional I/O lines are shown in FIG. 8 by the reference number 92 communicating with the electronics 94 while the bi-directional aspect of the communications with the interface 96 is shown by the reference number 98.

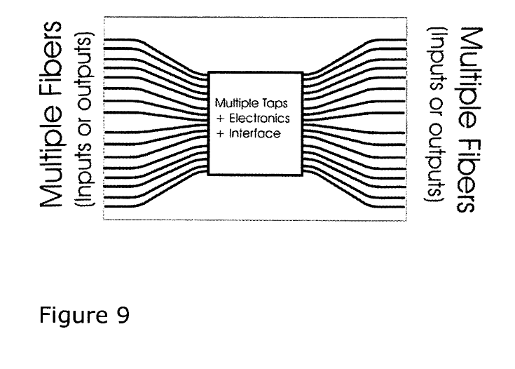

In another version of the device, illustrated generally in FIG. 9, multiple fibers 100, each with one or more optical taps, can be packaged together. In this configuration, the electronics can be shared amongst the taps and detectors, resulting in minimal overall size. This configuration can use individual detectors per tap, or detector arrays that incorporate multiple detectors in a small package. As before, multiple taps and detectors per fiber can be incorporated into the design, with or without optical filters, to monitor the power traveling in either direction, or both directions. The housing 102 contains the taps, detectors, electronics (including, for example, a wireless transceiver), and the microcontroller/interface.

Since the electronics is shared among the channels, the overall size is only slightly larger than that required for monitoring a single tap. Similarly, the manufacturing cost is only slightly more than for one tap.

Depending on the specific application, the monitor fibers of the present invention can be powered by an external power supply, by a built-in battery, by a solar rechargeable battery, or even through the communications interface in some instances. Even if a wireless communication interface is used along with a built-in battery, the entire electronics package can be made smaller than a matchbox. This gives a great deal of flexibility in terms of the configuration. With very low power consumption, it is well suited to permanent or long-term installation anywhere it might be desirable to monitor optical power within a fiber optic network.

In all of the embodiments disclosed herein it is clear that substantial economies in comparison to known monitoring techniques are realized through utilization of the proprietary optical fiber taps in combination with appropriate communications technology to effect remote reading of detected power levels and also remote control of the monitoring sites if necessary. Technicians are not required to always effect hard physical connections with the monitoring equipment, saving time in the acquisition of performance data and the subsequent analysis thereof. With wireless transmission capabilities and smart cell phone technology a technician can obtain data remote from the monitoring site and can communicate with a central computer or centrally-located troubleshooters who can provide the required analysis based on the acquired data and then advise the on-site technician as to whatever repairs might be necessary in the circumstances.

1. An optical fiber monitoring arrangement comprising:
a monitoring fiber formed from an optical fiber having a core and a cladding and suitably modified to include a zone of altered refractive index defining an optical channel extending from the fiber core to the outer surface of the fiber said channel diverting therealong a portion of light traveling along the core;
detector means positioned adjacent said monitoring fiber for receiving light diverted along said channel and for transforming said diverted light to an electrical signal; and
signal conveying means connected to said detector means for conveying said electrical signal to receiver means for further processing and analysis.

2. The arrangement of claim 1 wherein said signal conveying means comprises data transmitter means.

3. The arrangement of claim 2 wherein said data transmitter means includes transceiver means for receiving a control signal from an external transmitter.

4. The arrangement of claim 2 including at least two zones of altered refractive index in said monitoring fiber, defining at least two associated channels for diverting light traveling in the same or opposite directions within said core, each said at least two channels having a said detector means associated therewith.

5. The arrangement of claim 4 including switching means for connecting said data transmitter means to a selected one of said detector means.

6. The arrangement of claim 4 including optical filter means positioned between said monitoring fiber and said or each detector means for filtering light passing from the or each channel to the associated detector means.

7. The arrangement of claim 1 including optical filter means positioned between said monitoring fiber and said detector means for filtering light passing from said channel to the detector means.

8. The arrangement of claim 2 wherein said data transmitter means includes a wireless transmitter.

9. A fiber optic network interconnecting a plurality of spaced apart building units by way of an optical network including a plurality of optical fibers constituting such optical network, comprising at least one optical fiber monitoring arrangement according to claim 1 integrated into such optical network and associated with at least one of said optical fibers, said arrangement monitoring such optical network and providing an indication of problems associated with such optical network.

10. The fiber optic network according to claim 9 wherein such optical network includes a plurality of nodes with a said optical monitoring arrangement being built onto the optical fiber of each node.

11. A fiber optic network interconnecting a plurality of residential and/or commercial units within one or more buildings by way of an optical network including a plurality of optical fibers constituting such optical network, comprising at least one optical fiber monitoring arrangement according to claim 1 integrated into such optical network and associated with at least one of said optical fibers, said arrangement monitoring such optical network and providing an indication of problems associated with such optical network.

12. The fiber optic network according to claim 11 wherein such optical network includes a plurality of nodes with a said optical monitoring arrangement being built onto the optical fiber of each node.
